(19) United States
(12) Patent Application Publication
(10) Pub. No.: US 2004/0268123 A1
(43) Pub. Date: Dec. 30, 2004

(54) Security for protocol traversal

(75) Inventors: Franck Le, Irving, TX (US); Stefano M. Faccin, Dallas, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/721,504

(22) Filed: Nov. 26, 2003

Related U.S. Application Data
(60) Provisional application No. 60/482,763, filed on Jun. 27, 2003.

(51) Int. Cl. H04L 9/00

(52) U.S. Cl. 713/160

(57) ABSTRACT

A method for protecting packets to be sent from a first network node to a second network node is provided. According to one embodiment, the method includes the steps of generating validity information for a packet, and generating a header for the packet, including the validity information. The method also includes the step of sending the packet including the header from the first network node to the second network node. The validity information includes all necessary information required for performing a validity check of the packet. Thus, no pre-established security association is needed to verify the validity of a packet.

### CROSS-REFERENCE TO RELATED APPLICATIONS

This application claims priority of U.S. Provisional Application Ser. No. 60/482,763 entitled, “Security for Protocol Traversal,” filed Jun. 27, 2003, the entire contents of which are incorporated herein by reference.

### BACKGROUND OF THE INVENTION

1. Field of the Invention

This invention relates to a method and a system for protecting packets to be sent from a first network node to a second network node.

2. Description of the Related Art

This invention is related to security and more particularly security protocols to protect user packets. There are currently two main security protocols; Ipsec (Internet Protocol Security, as described, for example, in S. Kent, R. Atkinson, Security Architecture for the Internet Protocol”, RFC 2401, November 1998) and SKIP (Simple Key Management for Internet Protocols, information is available, for example, from www.skip.org, an overview can be found in http://www.tik.ee.ethz.ch/-skip/SKIP.html).

Ipsec requires that two communication nodes have a pre-established Security association. A security association (SA) is a set of policy and key(s) used to protect information. The particular security association is identified and retrieved by a Security Parameter Index (SPI) included in each packet. The establishment of the Security Association can be performed through several mechanisms such as IKE (Internet Key Exchange, described, for example, in D. Harkins, D. Carrel, “The Internet Key Exchange (IKE)” RFC 2409, November 1998) but this usually requires several messages between the two end points.

SKIP is a connectionless protocol (no connection set up is required) but all the information is carried in the SKIP header, this includes the encryption algorithm used, as well as the keying material that the receiving end will use to derive the session key. SKIP, however, relies on so-called Diffie-Hellman public values. For this, it is necessary that both nodes know each other, since it is required that both nodes exchange their Diffie-Hellman public values. That is, it is required that both nodes know the other node's authenticated public value (i.e. Diffie-Hellman value) in order to compute a pairwise symmetric key.

Apart from the problem that the sending node and the receiving node have to know the other one's Diffie-Hellman public value, there is also a problem in the case where the intermediate nodes need to perform a verification of the validity of a sent packet (e.g., in firewalls and the like). In this case, it is also necessary that the intermediate node knows the Diffie-Hellman public value of the sending node and the receiving node, and, if necessary, that also the sending node and the receiving node know the Diffie-Hellman public value of the intermediate node. This limits the freedom of transport in the Internet, since in this case the route to be taken by the packet has to be known.

Thus, the solutions known in the prior art require that the nodes which are involved in a transmission of a packet need to verify the validity thereof know each other before starting the actual transmission of the packet. Therefore, additional messages are required which lead to an increased amount of traffic. Moreover, managing the network is complicated since, before performing the actual transmission, it is necessary to make sure that all nodes (i.e., also intermediate nodes) involved have the required information for verifying the validity of the packet. This limits the freedom of the routes to be taken by a packet.

### SUMMARY OF THE INVENTION

The invention, according to one embodiment, provides a method for protecting packets to be sent from a first network node to a second network node. The method includes the steps of generating validity information for a packet and generating a header for the packet, including the validity information. The method also includes the steps of sending the packet including the header from the first network node to the second network node. The validity information includes all the necessary information required for performing a validity check of the packet.

According to another embodiment, the invention provides a network node for sending packets to a receiving network node. The network includes a mechanism for generating validity information for a packet and a mechanism for generating a header for the packet, including the validity information. The network also includes a mechanism for sending the packet including the header to the receiving network node. The validity information includes all the necessary information required for performing a validity check of the packet.

According to a further embodiment, the invention provides a network node for receiving packets from a sending network node. The network node includes a mechanism for performing a validity check of a packet by referring to validity information contained in the header of the packet in an intermediate node. The validity information includes all the necessary information required for performing a validity check of the packet.

Furthermore, according to another embodiment, the invention provides a network node for forwarding packets from a sending network node to a receiving network node. The network node includes a mechanism for performing a validity check of a packet by referring to validity information contained in the header of the packet. The validity information includes all necessary information required for performing a validity check of the packet.

### BRIEF DESCRIPTION OF THE DRAWINGS

FIG. 1 shows the basic configuration of a network including a sending node, a middle, i.e., an intermediate node and a receiving node according to a first embodiment of the invention;

FIG. 2 shows a flowchart illustrating a creation and sending of a packet including a security header according to the first embodiment of the invention;

FIG. 3 shows header fields of the security header according to the first embodiment of the invention;

FIG. 4 shows a flowchart illustrating a validity check performed by the receiving node and by the middle node according to the first embodiment of the invention; and

FIG. 5 shows a further example for a header format according to the first embodiment.

### DETAILED DESCRIPTION OF THE PREFERRED EMBODIMENTS

In the following, preferred embodiments are described by referring to the enclosed drawings.

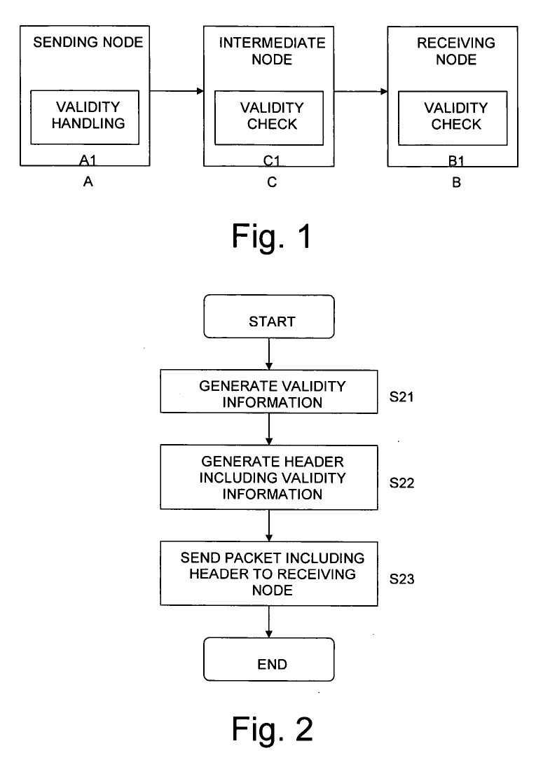

FIG. 1 shows a principle block diagram of network nodes concerned in the embodiments of the invention. Reference A denotes a first node, which is a sending node in this case. The node A may be a server, some kind of host, a user entity such as a Personal Computer connected to the Internet, a mobile node such as a mobile telephone or the like. The node A includes a validity handling function Al which serves to generate validity information and to insert this information into a header of a packet, as will be described later in more detail.

Reference B of FIG. 1 denotes a receiving node. This node can be, similar to the node A, a server, some kind of host, a user entity such as a Personal Computer connected to the Internet, a mobile node such as a mobile telephone or the like. The node B includes a validity check function B 1 which serves to check the validity of a received packet based on the validity information included in the header of the received packet, as will described later in more detail.

Reference C of FIG. 1 denotes a middle node or intermediate node. The node C can have the same structure as the node B, i.e., can be a server or the like, or can be a router. The intermediate nodes are also called middle-box 5 entities (described, for example, in http://www.ietf.org/html.charterS/midcOlWcharter.html) in IETF. Similar to the receiving node B, also such an intermediate node might need to verify the validity of the message and to make sure that the message was sent from A and was not modified along the way (data origin authentication, integrity protection). Thus, also the intermediate node C includes a validity check function C1, similar as the corresponding validity check function B1 of the node B.

It is noted that node A may not be aware of the intermediate nodes. The intermediate nodes should therefore not need to have a pre-established security association with node A (e.g. IPsec SA).

Hence, according to the invention, the separate nodes do need the validity information received by means of the security header in order to verify the validity of a received packet. Thus, the nodes B and C do need only the validity check function, but do not need to have further functions related to establishing a security association or the like.

It is noted that the validity information can also include a pointer instead of the sender's public key. Namely, the public key may be too long to be carried into the header. Thus, instead of the public key, the validity information may contain a pointer to the public key of A (e.g., the address in a database of a corresponding server or the like).

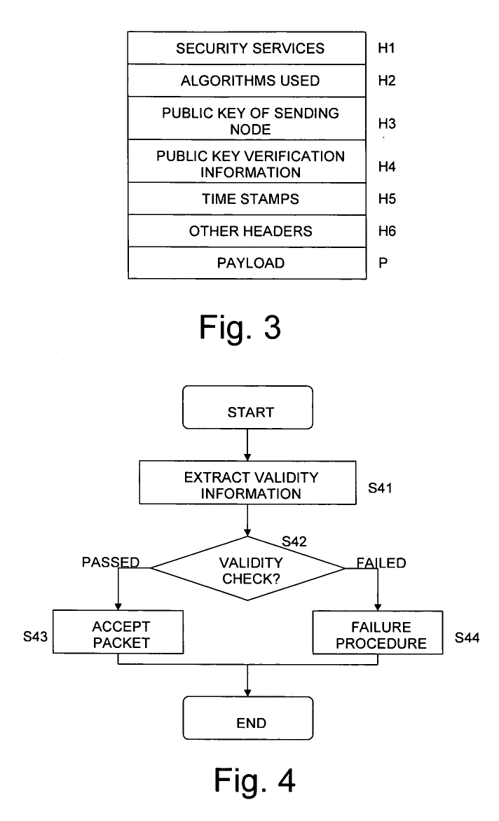

FIG. 2 shows a flowchart illustrating the basic procedure of how the security header according to the first embodiment of the invention is generated in the node A. The procedure starts when a packet is to be generated or is to be sent. In step S21, the validity information is generated. The content of the validity information is described later with respect to FIG. 3. In step S22, the validity information generated in step S21 is inserted into the header, and in step S23, the packet including the header is sent to its destination, namely the node B. During transmission, it may pass the node C.

Referring to FIG. 3, the structure of the header 15 according to the first embodiment is described. It is noted that the structure shown in the drawing does not necessarily represent the actual order of the headers, but gives an overview about the header fields according to the example shown in this embodiment.

The new security header includes the following information, which is referred to as the validity information.

Security services (field H1): this field informs the receiving nodes about the security services that have been applied to the packet (e.g. encryption, integrity protection, etc.) The field H2 includes information regarding the algorithms used. The field H3 includes information regarding the public key of the sending node. Alternatively, field H3 may contain a pointer to the sender's public key since the public key itself may be too long to be carried in the packet, as described above.

The field H4 includes the Public Key verification information. This information indicates how the receiving nodes can verify that the Public Key belongs to the claimed entity (i.e., the sending node). This field can e.g. include a Certificate, or just the indication that CGA has been applied (CGA: Cryptographically Generated Address, as described, for example, in Cryptographically Generated Addresses by Tuomas Aura, February 2003, (http://www.ietf.org/internet-drafts/draft-aura-cga-OO.txt).

As for the public key described above, the certificate may be too long. Therefore, the field H4 may also carry a pointer including information as to where to retrieve the relevant certificate to verify the validity of this packet. The pointer may include the address of a corresponding server, for example, and a more detailed address for accessing a database within this server, for example.

The field H5 may include information regarding the Time stamps for the replay protection.

In FIG. 3, other headers necessary for the packet (e.g., addresses and the like) are denoted by the field H6. The actual payload of the packet is denoted by the reference P.

Thus, by using the above information, the receiving node B and intermediate node(s) C can check the validity of the packet based only on the received validity information.

The principle of the validity check is illustrated in the flowchart of FIG. 4. In step S41, the validity information is extracted from the header of a received packet. In step S42, the validity check is performed, and depending on the result (i.e., whether the packet fails or passes validity check), the packet is accepted (step S43), or a failure procedure is started (step S44). The failure procedure may be discarding of the packet and/or informing the user of the receiving and/or sending node that the packet has be corrupted. In case of an intermediate node, the packet is forwarded after it has been accepted in step S43.

The validity check is performed based on the information contained in the different fields of the security header according to examples of the invention discussed herein. The security services information in field H1 indicates to the validity check function B1/C1 of the receiving/middle node which security service is present. That is, based on this information the validity check function can decide how the validity check has to be performed. The field H2 including the algorithm information indicates which algorithm the validity check function has to use in order to perform the validity check. The field H3 indicates the public key of the sending node which is required to compute a key in order to check the validity. If necessary, the information in field H4 can be used to verify that the received public key is indeed the public key of the sending node. The information in field H5 (time stamp) can be used to check whether the packet is still “valid”, or whether it is out-of-date, in order to avoid a replay attack.

Thus, the receiving node or an intermediate node can perform a validity verification without relying on a security association or preset public key values or the like. That is, the receiving node and intermediate nodes can perform the validity check independently from further security information.

The new security header according to the invention can be used, for example:

To protect transparent traversal protocols like TIST (described, for example, in Melinda Shore, The TIST (Topology-Insensitive Service Traversal) Protocol, Internet draft, May 2002),

To provide security in environments where Proxies are deployed: A proxy may create/modify the user state based on the received messages and it therefore needs to make sure that the messages are coming from the valid user and have not been modified, and/or

To securely update the state of stateful inspection packet filters (Firewalls) when Mobile IP is used.

Thus upon receipt of the messages, thanks to the information carried in the header, the intermediate nodes will be able to verify the validity of the packets. Typically, the sender will sign the messages using the Private Key corresponding to the Public Key sent in the message header.

As when Ipsec was first deployed, for legacy network entities, this invention can be implemented using a “Bump in the Stack” implementation (also described in S. Kent, R. Atkinson, “Security Architecture for the Internet Protocol”, RFC 2401, November 1998). That is, in “Bump-in-the-stack” (BITS) implementations, IPsec is implemented “underneath” an existing implementation of an IP protocol stack, between the native IP and the local network drivers. Source code access for the IP stack is not required in this context, making this implementation approach appropriate for use with legacy systems. This approach, when it is adopted, is usually employed in hosts.

Otherwise, for other implementations, the invention can be implemented as described above with respect to FIGS. 1 to 4.

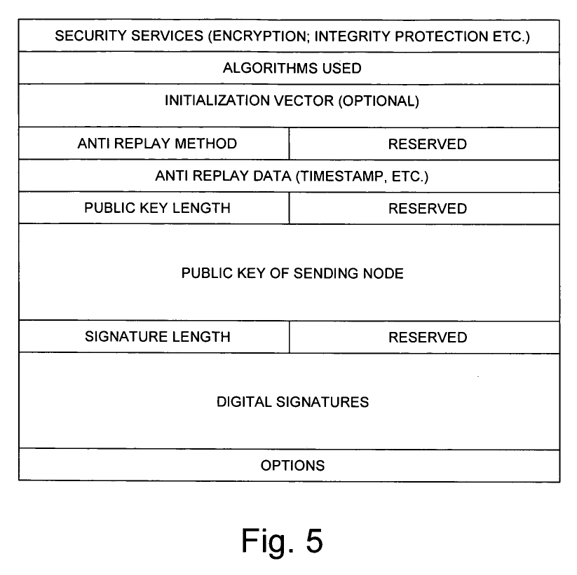

As mentioned above, the order of the header fields is not limited to the example shown in FIG. 3. FIG. 5 illustrates a further possible format.

In addition, in the above description of the first embodiment, time stamp was given as an example for a mechanism to prevent replay attack. However, also other suitable mechanisms to prevent replay attacks can be used. That is, in the header some other suitable information item for preventing replay attacks may be introduced.

Another example for a mechanism for preventing replay attacks is the use of nonces. Further applicable anti-replay attack mechanisms are described in document: “On Preventing Replay Attacks on Security Protocols” by Sreekanth Malladi, Jim Alves-Foss, Robert B. Heckendorn, Center for Secure and Dependable Systems, Department of Computer Science, University of Idaho, Moscow, ID 83844 USA http://www.cs.uidaho.edu/—jimaf/docs/replay02.pdf.

A second embodiment of the invention is described below.

According to the second embodiment, not every single packet will contain the security header. In particular, according to the second embodiment, the security header is added only to some specific packets. Possible applications are Mobile IPv6 and NSIS (Next Steps In signaling, described in http://www.ietf.org/html.charters/nsis-charter.html, for example). In Mobile IPv6 case, in order to allow firewalls to be able to process Mobile IPv6 packets correctly and therefore detect, read and authenticate Binding Update messages without requiring the firewall (FW) and the multiple node (MN) to have a pre-shared security relation, only packets containing Binding Update messages need to have such security header. In case of NSIS signaling used e.g. in the TIST meaning (i.e. to allow a MN to communicate with a firewall without sharing any security association), again only specific packets carrying the signaling will contain the security header. So, the processing of asymmetric encryption is limited to a few elements in the networks and only to a few packets, and not to all packets of the communication.

Hence, the amount of information to be included in the communication packets as a whole is reduced, since only a part of the packets contain the security header according to the invention. Moreover, the operation load is reduced since not every single packet has to be checked with respect to the validity thereof.

The invention is not limited to the embodiments described above but can vary within the scope of the claims.

For example, the above embodiments can be freely combined. For example, there may be cases where for one kind of communication (e.g., requiring a high degree of security) every single packet contains the security header, whereas for other kinds of communication only a part of the packets contain the security header.

Moreover, it is not necessary to include the actual public key into the header. Namely, public keys may be stored in some database. Therefore, a protocol may be adapted by which the public key can be retrieved from such a database. Such a protocol is defined for SKIP, for example, such that this existing protocol can easily be adapted. It is noted that there is only one retrieval necessary for a series of packets, since all packets within one communication will carry the same public key. This also reduces the amount of information to be carried with in a header.

Hence, the validity information in the header may include the entity (e.g., the database) from which the public key can be obtained. Alternatively, the validity information may include a public key identifier for the public key.

Furthermore, it is not required that every node receiving or processing the packet needs to verify the header. Therefore, also in cases in which each packet has the new security header according to the invention, the necessary operation load is limited.

In addition, in the first embodiment only one intermediate network node C has been described. However, there may be a plurality of intermediate network nodes adapted to perform a validity verification.

Thus, the invention enables a protection of packets to be sent from a first network node to a second network node, wherein the amount of protocol messages is reduced and a flexible routing of the packet is possible.

Thus, according to the invention, every network node involved in transmitting a packet (i.e., the receiving node or any intermediate node) can rely only on the validity information included in the header (i.e., the new security header according to the invention) in order to perform a validity verification of a packet.

Hence, the nodes do not need to have any pre-established information (e.g. Security Association), or have to exchange key values beforehand. That is, there is no security nor state required, and no connection set up overhead is produced.

That is, any node on the path that needs to verify the validity of the messages can do so. Each packet can be processed independently from the others.

In addition, for security reasons, it is preferable that the communicating nodes do not know the address or any other characteristics of a firewall or other middle node that may need to process the exchanged data/or perform some operations based on them. Therefore, since according to the invention the authentication of the packets can be processed independently, the security in a network can be enhanced.

The validity information may include security information indicating security services applied to the packet.

Furthermore, the validity information may include algorithm information to be used for performing a validity check of the packet.

The algorithm information may indicate an algorithm to be used for performing a validity check of the packet. Moreover, the algorithm information may include values to initialize the algorithm to be used for performing a validity check of the packet.

The validity information may include public key information of the sending node

The public key information may include reference information on how the public key can be obtained. Hence, it is not necessary that the actual public key is included in the header, such that the size of the header can be maintained sufficiently small. The reference information may comprise the identity of an entity form which the public key can be obtained, or may include a public key identifier for the public key.

However, if possible, the public key information may alternatively include the public key itself.

The public key information may comprise public key verification information indicating information in order to verify that the public key actually belongs to the sending node

The validity information may include an information item for preventing replay attacks. That is, a mechanism to prevent replay attacks may be used, and the necessary information or data may be included in the header.

The information item for preventing replay attacks may contain an indication of the method to be used for anti replay attacks.

The information item for preventing replay attacks may contain a time stamp. However, also other mechanisms are possible, such as use of nonces and the like.

Furthermore, the packet may be signed using a private key corresponding to the Public Key indicated by the validity information in the packet header in the sending network node.

Moreover, in the receiving node, a validity check of a packet may be performed by referring to the validity information contained in the header of the packet.

In addition, a validity check of a packet may be performed by referring to the validity information contained in the header of the packet in an intermediate node. Thus, also an intermediate node may check the validity of the packet. The packet may be sent by, e.g., Internet Protocol. The network node may be a mobile network node.

1. A method for protecting packets to be sent from a first network node to a second network node, comprising the steps of:
generating validity information for a packet, wherein the validity information comprises all necessary information required for performing a validity check of the packet;
generating a header for the packet, comprising the validity information; and
sending the packet including the header from a first network node to a second network node.

2. The method according to claim 1, wherein the step of generating the validity information comprises generating security information indicating security services applied to the packet.

3. The method according to claim 1, wherein the step of generating the validity information comprises generating algorithm information to be used for performing the validity check of the packet.

4. The method according to claim 3, wherein the step of generating the algorithm information comprises generating the algorithm information which indicates an algorithm to be used for performing the validity check of the packet.

5. The method according to claim 3, wherein the step of generating the algorithm information comprises generating the algorithm information which comprises values to initialize an algorithm to be used for performing the validity check of the packet.

6. The method according to claim 1, wherein the step of generating the validity information comprises generating public key information of a sending node.

7. The method according to claim 6, wherein the step of generating the public key information comprises generating reference information related to how a public key can be obtained.

8. The method according to claim 7, wherein the step of generating the reference information comprises generating an identity of an entity from which the public key can be obtained.

9. The method according to claim 7, wherein the step of generating the reference information comprises generating a public key identifier for the public key.

10. The method according to claim 6, wherein the step of generating the public key information comprises generating the public key.

11. The method according to claim 6, wherein the step of generating the public key information comprises generating public key verification information indicating information in order to verify that the public key actually belongs to the sending node.

12. The method according to claim 1, wherein the step of generating the validity information comprises generating an information item for preventing replay attacks.

13. The method according to claim 12, wherein the step of generating the information item comprises including in the information item an indication of a procedure to be used for anti replay attacks.

14. The method according to claim 12, wherein the step of generating the information item comprises including in the information item a time stamp.

15. The method according to claim 6, further comprising the step of:
signing the packet using a private key corresponding to the Public Key indicated by the validity information in the packet header in a sending network node.

16. The method according to claim 1, further comprising the step of:
performing a validity check of the packet by referring to the validity information contained in the header of the packet in a receiving node.

17. The method according to claim 1, further comprising the step of:
performing a validity check of a packet by referring to the validity information contained in the header of the packet in an intermediate node.

18. A network node for sending packets to a receiving network node, comprising:
first generating means for generating validity information for a packet;
second generating means for generating a header for the packet, comprising the validity information; and
sending means for sending the packet including the header to a receiving network node, wherein the validity information comprises all necessary information required for performing a validity check of the packet.

19. A network node comprising:
receiving means for receiving packets from a sending network node; and
performing means for performing a validity check of a packet by referring to validity information contained in a header of the packet,
wherein the validity information comprises all necessary information required for performing the validity check of the packet.

20. A network node comprising:
forwarding means for forwarding packets from a sending network node to a receiving network node; and
performing means for performing a validity check of a packet by referring to validity information contained in a header of the packet,
wherein the validity information comprises all necessary information required for performing a validity check of the packet.

21. The network node according to claim 18, wherein the validity information comprises security information indicating security services applied to the packet.

22. The network node according to claim 18, wherein the validity information comprises algorithm information indicating an algorithm to be used for performing the validity check of the packet.

23. The network node according to claim 18, wherein the validity information comprises public key information of a sending node.

24. The network node according to claim 23, wherein the public key information comprises reference information related to how a public key can be obtained.

25. The network node according to claim 24, wherein the reference information comprises an identity of an entity from which the public key can be obtained.

26. The network node according to claim 24, wherein the reference information comprises a public key identifier for the public key.

27. The network node according to claim 23, wherein the public key information comprises a public key.

28. The network node according to claim 23, wherein the public key information comprises public key verification information indicating information in order to verify that the public key actually belongs to the sending node.

29. The network node according to claim 18, wherein the validity information comprises an information item for preventing replay attacks.

30. The network node according to claim 29, wherein the information item for preventing replay attacks contains an indication of a procedure to be used for anti-replay attacks.

31. The network node according to claim 29, wherein the information item for preventing replay attacks contains a time stamp.

32. The network node according to claim 23, further comprising:
signing means for signing the packet using a private key corresponding to a Public Key indicated by the validity information in the packet header in the sending network node.

33. The network node according to claim 18, wherein the network node comprises a mobile network node.

34. A network system comprising:
a first network node configured to send a packet, wherein the first network node comprises first generating means for generating validity information for a packet, second generating means for generating a header for the packet, comprising the validity information; sending means for sending the packet including the header to a receiving network node, wherein the validity information comprises all necessary information required for performing a validity check of the packet; and
a second network node configured to receive the packet, wherein the second network node comprises performing means for performing a validity check of a packet by referring to validity information contained in a header of the packet, wherein the validity information comprises all necessary information required for performing the validity check of the packet.

35. The network system according to claim 34, further comprising:
at least one intermediate node for forwarding packets from a sending network node to a receiving network node, wherein the at least one intermediate node comprises performing means for performing a validity check of a packet by referring to the validity information contained in a header of the packet.

36. The network node according to claim 19, wherein the validity information comprises security information indicating security services applied to the packet.

37. The network node according to claim 20, wherein the validity information comprises security information indicating security services applied to the packet.

38. The network node according to claim 19, wherein the validity information comprises algorithm information indicating an algorithm to be used for performing the validity check of the packet.

39. The network node according to claim 20, wherein the validity information comprises algorithm information indicating an algorithm to be used for performing the validity check of the packet.

40. The network node according to claim 19, wherein the validity information comprises public key information of a sending node.

41. The network node according to claim 20, wherein the validity information comprises public key information of a sending node.
